(19) United States
(12) Patent Application Publication
(10) Pub. No.: US 2024/0153753 A1
(43) Pub. Date: May 9, 2024

(54) ATMOSPHERIC PRESSURE IONIZATION COUPLED TO AN ELECTRON IONIZATION MASS SPECTROMETER

(71) Applicant: Inficon Inc., East Syracuse, NY (US)

(72) Inventor: Nigel Sousou, Liverpool, NY (US)

(21) Appl. No.: 18/382,570

(22) Filed: Oct. 23, 2023

Related U.S. Application Data
(60) Provisional application No. 63/423,190, filed on Nov. 7, 2022.

(51) Int. Cl. H01J 49/14; H01J 49/00

(52) U.S. Cl. CPC H01J 49/147; H01J 49/0031; H01J 49/0054; H01J 49/0072

(57) ABSTRACT

An atmospheric pressure electron impact ionization mass spectrometer system includes an atmospheric pressure ionization component operated at an atmospheric pressure. An electron impact ionization mass spectrometer includes an electron ionization source. An atmospheric pressure interface operates below about 10 Torr. The atmospheric pressure interface includes a source block to focus a plurality of molecules and ions from the atmospheric pressure ionization component at the atmospheric pressure into the electron ionization source which operates at a pressure below about 10⁻³ Torr.

### CROSS REFERENCE TO RELATED APPLICATION(S)

The present application claims the benefit of and priority to U.S. provisional Application Ser. No. 63/423,190, filed Nov. 7, 2022, the entire contents of which are hereby incorporated by reference herein.

### TECHNICAL FIELD

The application relates to mass spectrometry, and particularly, relates to atmospheric pressure ionization techniques for use with an electron ionization mass spectrometer.

### BACKGROUND

Bioanalytical techniques used in small molecule drug discovery typically utilize atmospheric pressure ionization techniques.

### SUMMARY

An atmospheric pressure electron impact ionization mass spectrometer system includes an atmospheric pressure ionization component operated at an atmospheric pressure. An electron impact ionization mass spectrometer includes an electron ionization source. An atmospheric pressure interface operates below about 10 Torr. The atmospheric pressure interface includes a source block to focus a plurality of molecules and ions from the atmospheric pressure ionization component at the atmospheric pressure into the electron ionization source which operates at a pressure below about 10⁻³ Torr.

The atmospheric pressure ionization component can include an electrospray ionization (ESI) component. The atmospheric pressure ionization component can include an atmospheric pressure chemical ionization (APCI) component. The atmospheric pressure ionization component can include an atmospheric pressure analysis probe (ASAP) component.

The atmospheric pressure electron impact ionization mass spectrometer system can further include a processor operatively coupled to at least the electron impact ionization mass spectrometer. The processor is configured and adapted to run a mass spectrometer analysis process. The electron ionization source can include a 70 eV electron ionization source and the mass spectrometer analysis process can be configured for a direct look up with an established 70 eV mass spectral library database. The electron ionization source can include a 40 eV electron ionization source.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a drawing illustrating an exemplary 70 eV EI mass spectra identification of caffeine;

FIG. 2 is a drawing showing an exemplary API/EI (atmospheric pressure ionization/electron ionization) mass spectrometer system according to one or more illustrative embodiments of the present disclosure;

FIG. 3 is a drawing showing a schematic diagram with an exemplary API/EI mass spectrometer system according to one or more illustrative embodiments of the present disclosure;

FIG. 4 is a flow chart illustrating a process for analyzing a sample according to one or more illustrative embodiments of the present disclosure; and

FIG. 5 illustrates a distributed communications network according to one or more illustrative embodiments of the present disclosure.

### DETAILED DESCRIPTION

Bioanalytical techniques used in small molecule drug discovery (<2000 Dalton (Da)) typically utilize atmospheric pressure ionization techniques (including, for example, and without limitation e.g., ElectroSpray Ionization (ESI) and Atmospheric Pressure Chemical Ionization (APCI)) that require very experienced technicians to interpret the data generated during the techniques and processes.

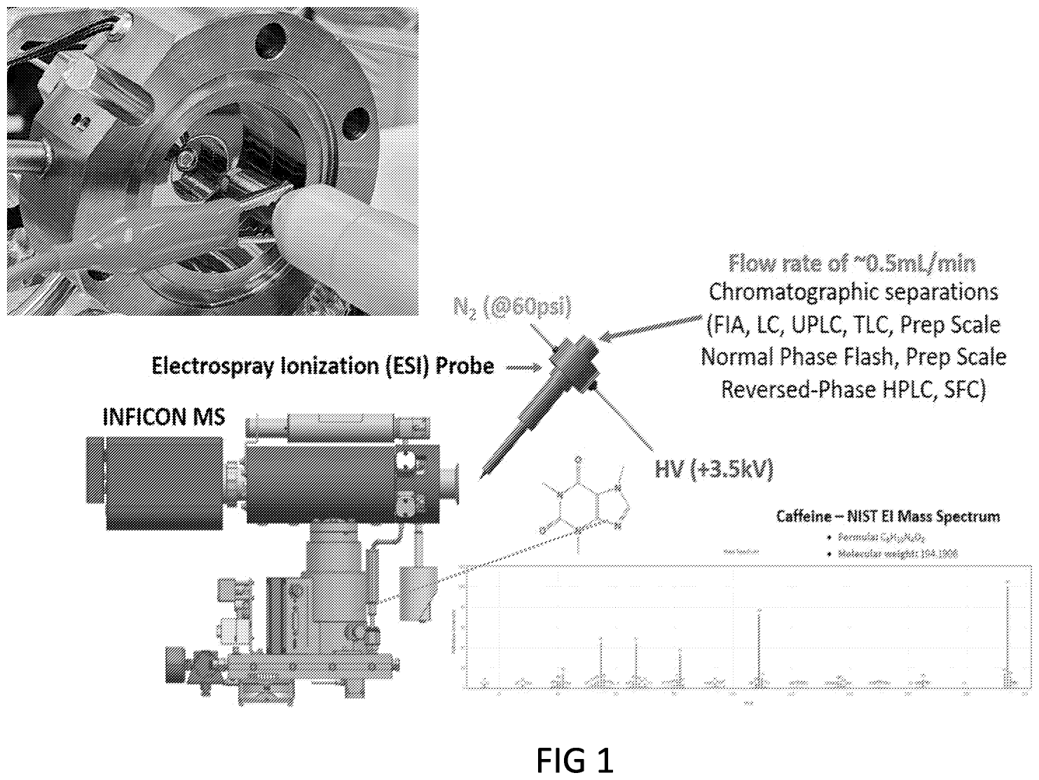

Analytes are typically detected as molecular ion adducts such as [M+H]+, [M+Na]+, [M+K]+, [M+ACN]+, [M+MeOH]+, etc. Detecting analytes as molecular ion adducts results in very complex mass spectra. Fragmentation due to collisional induced dissociation can further complicate the mass spectra. These mass spectra are not library searchable, and the mass spectra can be vastly different amongst different instruments, various settings and other parameters. For example, FIG. 1 is a drawing showing an exemplary 70 eV EI mass spectra identification of caffeine.

It was realized that atmospheric pressure ionization (API) can be combined with electron ionization (EI) as an API/EI mass spectrometer. The new combined API/EI mass spectrometer can produce a 70 eV EI mass spectra. A 70 eV EI mass spectra is library searchable using NIST and Wiley Libraries (e.g., searchable by the NIST Chemistry WebBook; NIST20: NIST Tandem and Electron Ionization Spectral Libraries). The NIST Chemistry WebBook provides users with easy access to chemical and physical property data for chemical species through the internet. The data provided in the site are from collections maintained by the NIST Standard Reference Data Program and outside contributors. Data in the WebBook system are organized by chemical species. The WebBook system allows users to search for chemical species by various means. Once the desired species has been identified, the system will display data for the species.

Such API/EI mass spectra have been unachievable to date. It is believed that this new synergy made possible by the new combination of API and EI for mass spectrometry according to illustrative embodiments of the present invention, could revolutionize small molecule drug discovery in Pharma. The new API/EI mass spectrometer according to the illustrative embodiments can also be utilized in environmental applications, such as, for example, military and first responder applications, airport screening, academia as a research and teaching tool, etc.

The ease and speed of mass spectra interpretation by use of the new combination of an API and EI in an API/EI mass spectrometer substantially eliminates and minimizes the misinterpretation of mass spectra. Moreover, the user no longer needs to be a mass spectra expert, the user can simply click on the mass spectra and an analyte ID match is shown.

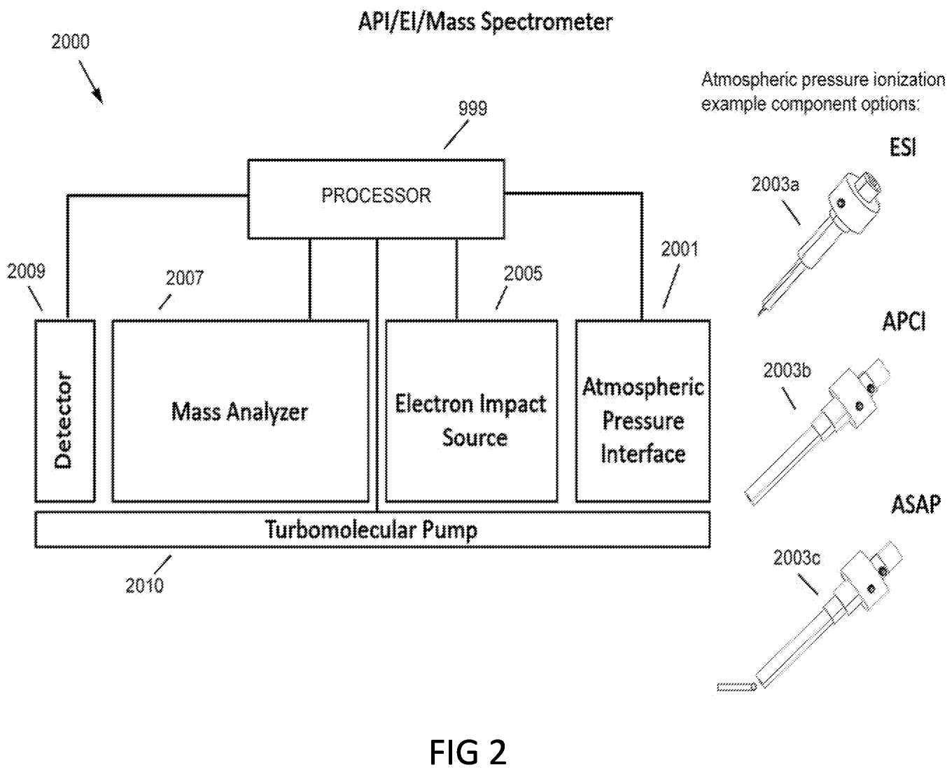

FIG. 2 is a drawing showing an exemplary API/EI mass spectrometer system 2000 according to one or more illustrative embodiments of the present invention. Atmospheric pressure ionization is performed by any suitable component, such as, for example, an electrospray ionization (ESI) device 2003a, an atmospheric pressure chemical ionization (APCI) device 2003b, or an atmospheric pressure analysis probe (ASAP) device 2003c. The sample molecules enter in liquid or solid form. A new atmospheric pressure interface 2001 focuses molecules and ions from the atmospheric pressure ionization device (e.g., 2003a, 2003b, or 2003c) into an electron impact ion source 2005. The atmospheric pressure interface 2001 includes new aspects and structures in combination, including one or more inlet capillaries, orifices, extraction lens aperture, as well as the turbo pumping system with an optimized gas flow dynamics.

The 70 eV products or fragments generated or produced by the electron impact ion source 2005 are analyzed by the mass analyzer 2007 and detector 2009. Any suitable detector 2009 with either an analog or a digital output can be used. A photomultiplier tube (PMT) is one example of a suitable analog detector type.

A processor 999 is operatively coupled to at least the mass analyzer 2007, and can be optionally coupled to any of the other components as shown in FIG. 2. Any suitable components can be used for the electron impact source 2005. Any suitable processor 999 can be used. It is understood that processor 999 can include any suitable memory, computer interface, and optionally an instrument display (not shown in FIG. 2).

It was realized that a new type of interface, such as atmospheric pressure interface 2001, can be used to achieve the new combination of an API/EI mass spectrometer in accordance with illustrative embodiments of the present disclosure. The new interface addresses issues with step down in pressure while also focusing the ions into the mass spectrometer. The atmospheric pressure interface 2001 provides both the pressure gradient from the atmospheric pressure ionization to the electron impact ion source 2005, as well as focusing, for example, electrostatically focusing, and steering ions and molecules from the atmospheric pressure ionization device 2003a, 2003b, 2003c into the electron impact ion source 2005. Front end flow dynamics allow for an opening to the atmosphere with differential pumping, without inundating the system, and while simultaneously allowing the electron ionization source to operate at relatively low pressure. In illustrative embodiments, the system including at least the atmospheric pressure interface 2001 enables differential pumping from atmospheric pressure to 2 mbar and then to 10⁻⁴ mbar. The ions are focused by one or more lenses and electrostatic fields into the electron impact ion source 2005.

In embodiments, the API/EI mass spectrometer system includes one or more of the components depicted in FIG. 2. In certain embodiments, the API/EI mass spectrometer system includes each of the components.

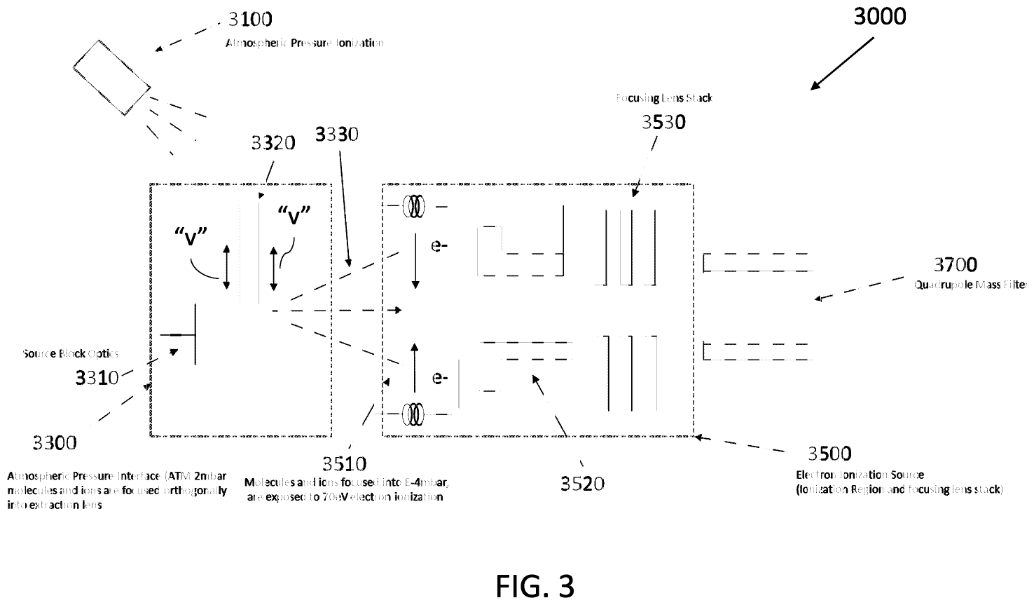

Example: FIG. 3 is a drawing showing a schematic diagram with annotation of a new API/EI spectrometer 3000 according to the illustrative embodiments of the present disclosure. The diagram includes both an exemplary hardware interface and two charts above which illustrate both the ion focusing and the transition from the atmospheric pressure of the API into the vacuum of ionization source of the EI mass spectrometer.

Atmospheric pressure ionization is performed by an ionization device 3100 (e.g., ESI, APCI, or ASAP of FIG. 2). Atmospheric pressure interface 3300 (an example of an atmospheric pressure interface 2001) includes source block 3310, e.g., the optics block guiding for focusing of ions and molecules. In embodiments, the exemplary atmospheric pressure interface 3300 of FIG. 3 includes the source block 3310 having an electrostatic plate 3315 and the cone shaped extraction lens 3330 (shown schematically). The atmospheric pressure interface 3300 accomplishes the pressure transition from the atmospheric pressure of the atmospheric pressure ionization device 3100 to a pressure of about 2 millibar (mbar) within the atmospheric pressure interface 3300. Ions and molecules are received into the tube/capillary 3320, which can be adjusted up or down as indicated by the vertical arrows “v” to be set at an optimized position. The position can be set by any suitable continuous or detent structure and adjusted by any suitable manual or motorized technique (e.g., by a stepper motor). The optics electrostatic plate 3310 of the atmospheric pressure interface 3300 causes molecules and ions to be orthogonally focused into the extraction lens 3330. The tube/capillary can be set up to, and optimized to about +200V; the source block can be set to, and optimized to about +50V; the extraction lens 3330 can be set to, and optimized to about +10V to provide a potential for an electrostatic gradient to focus ions into the electron ionization source 3500.

The atmospheric pressure interface 3300 focuses molecules and ions into the closed ion source (CIS) 3520 of the 10⁻⁴ mbar vacuum of ionization source 3500, where the ions and molecules are exposed to the 70 eV electron ionization. The 70 eV ionized molecules and ions from the ionization source 3500 are further focused into the mass spectrometer by a focusing lens stack 3530 and a quadrupole mass filter 3700.

Exemplative voltage gradients change from atmospheric pressure ionization device 3100 to the ionization source 3500 includes without limitation as follows. An exemplary working voltage at the atmospheric pressure ionization device 3100 is about 3,500 V to 5,000 V. The voltage at the inlet of the atmospheric pressure interface 3300 is about 200 V, and the voltage of the plate in the source block optics is about 50 V. The electrostatic plate 3310 of the source block optics is about +50V. The voltage at the extraction lens 3330, the cone shaped entrance where the ions enter into the electron ionization source 3500, is about 10 V. The voltages referenced hereinabove are the lens voltages focusing ions into the electron ionization source.

An exemplary progression of pressure drops from atmospheric pressure to vacuum below the voltage gradient line include without limitation as follows. From atmospheric pressure of the atmospheric pressure ionization device 3100, both of the inlet of the atmospheric pressure interface 3300 and the atmospheric pressure interface 3300 are at a pressure of about 2 mbar. The ionization source 3500 is at a pressure of about 2×10⁻⁴ Torr (˜10⁻⁴ mbar).

The differentially pumped regions can be maintained by any suitable vacuum pump, typically a turbo molecular pump, in combination of narrow-bore capillaries, orifices and extraction lens apertures. The inlet capillary allows for the first-stage step down of pressure from ATM to about 2 mbar, the combination of orifices and extraction lens apertures allows for the second-stage step down of pressure from 2 mbar to 10⁻⁴ mbar.

Optimally the atmospheric pressure electron impact ionization mass spectrometer system according to illustrative embodiments of the present disclosure operates with 70 eV electron ionization to make direct use of the NIST or Wiley databases. However, an atmospheric pressure electron impact ionization mass spectrometer system according to illustrative embodiments of the present invention can also use a 40 eV electron ionization source to operate at 40 eV electron ionization. The softer ionization of the lower emission 40 eV can be compatible with standard 40 eV analysis as is common in some semiconductor manufacturing industry applications.

Electrospray Ionization (ESI) (e.g., FIG. 2, 2003a) can be used for singly and multiply charged molecules (targeting acidic and basic molecules). Atmospheric Pressure Chemical Ionization (APCI) (e.g., FIG. 2, 2003b) or Atmospheric Pressure Analysis Probe (ASAP) (e.g., FIG. 2, 2003c) can be used for singly charged molecules (targeting neutral and non-polar molecules). A 70 eV EI can be used with an Electron Multiplier (EM) Detector Heated Inlet (>100 C). A Turbo bypass can evacuate the API (e.g., FIG. 2, 2001, FIGS. 3, 3300) to −2 mbar by, for example, supersonic expansion, while optimizing sampling of the Mach disc region—ion optics. There can be independent voltage control on Atmospheric Pressure Interface (API) lens (e.g., FIG. 3, 3330) such as, for example, by modification of the front-end to allow for individual voltage/gradients.

Mass spectrometer analysis process—The mass spectrometer analysis process can include tuning and mass calibration of the API-EI MS by controlling the various voltages, pneumatic valves, vacuum pumping system, detection optics and signal amplification and digitization. The process can also be operatively coupled to and control the conversion of analog to digital (ADC) conversion (e.g., an analog output from one or more detectors), and the plotting of mass spectrum on a user interface, such as, for example, by the processor and/or any suitable computer (desktop, laptop, notebook, tablet, etc.) allowing a user to seamlessly search library mass spectral databases, such as those described hereinabove.

Described hereinabove is a new type of atmospheric pressure ionization/liquid chromatographic separation techniques (electrospray ionization ESI, atmospheric pressure chemical ionization APCI) coupled to an electron impact ionization mass spectrometer. Atmospheric pressure ionization/solid analysis techniques (atmospheric solids analysis probe ASAP) can be coupled to an electron impact ionization mass spectrometer. An electrospray Ionization Probe Voltage from 1-5 kV (constant voltage, variable current) can use either a fused silica or stainless steel capillary. An atmospheric Pressure Ionization Current can be from about 1 to 5 mA (constant current, variable voltage) by use of either a fused silica or stainless steel capillary. A pneumatically operated atmospheric pressure ionization source (ESI, APCI, ASAP) can be operated at pressures ranging from about 30 to 150 psi. Suitable pneumatic gases include, for example, N2, O2, Air, inert gases (He, Ne, Ar, Kr, Xe), singular or combinations thereof. Suitable coaxial pneumatic heated desolvation gases (50-400 C) include, for example, N2, O2, Air, inert gases (He, Ne, Ar, Kr, Xe), singular or combinations thereof. A nano electrospray can use, for example, a micro-capillary, a chip (silicon wafer, glass or combination of both) and/or electrophoretic separation technologies coupled to an electron impact ionization mass spectrometer. An electron ionization energy can range from about 10 eV to 100 eV. Any suitable narrow bore capillary, orifice or combination of both can be used to differentially pump a mass spectrometer from about 760 Torr (atmospheric pressure) to 2 Torr. Any suitable heated inlet/interface/interstage assemblies can be used from about 50 C to 250 C. The mass spectrometer can be differentially pumped from about 760 Torr to <2 Torr. The mass spectrometer can be differentially pumped from about 760 Torr to <1×10⁻³ Torr. The mass spectrometer can be differentially pumped from 760 Torr to <1×10⁻⁶ Torr. Any suitable type of mass spectrometer can be used, including, for example, a single quadrupole, time-of-flight, ion trap as well as tandem and hybrid instruments. The mass spectrometer can be equipped with, for example, a faraday cup, an electron multiplier, a high energy conversion dynode, or any combination thereof. The mass spectrometer can have a mass range from about m/z 1 to 5000.

There can be an ability to turn off the EI to provide ESI, APCI or ASAP only mass spectra. There can be an ability to generate singly and multiply charges ion species. There can be a compilation of API/EI mass spectra by a processor into a library format. There can be a quadrupole, a hexapole or octupole ion focusing (e.g., RF only from about 300 to 1000 kHz, scanning amplitude or fixed amplitude) for ion transmission to facilitate collisional cooling of ions prior to entrance into the mass analysis component.

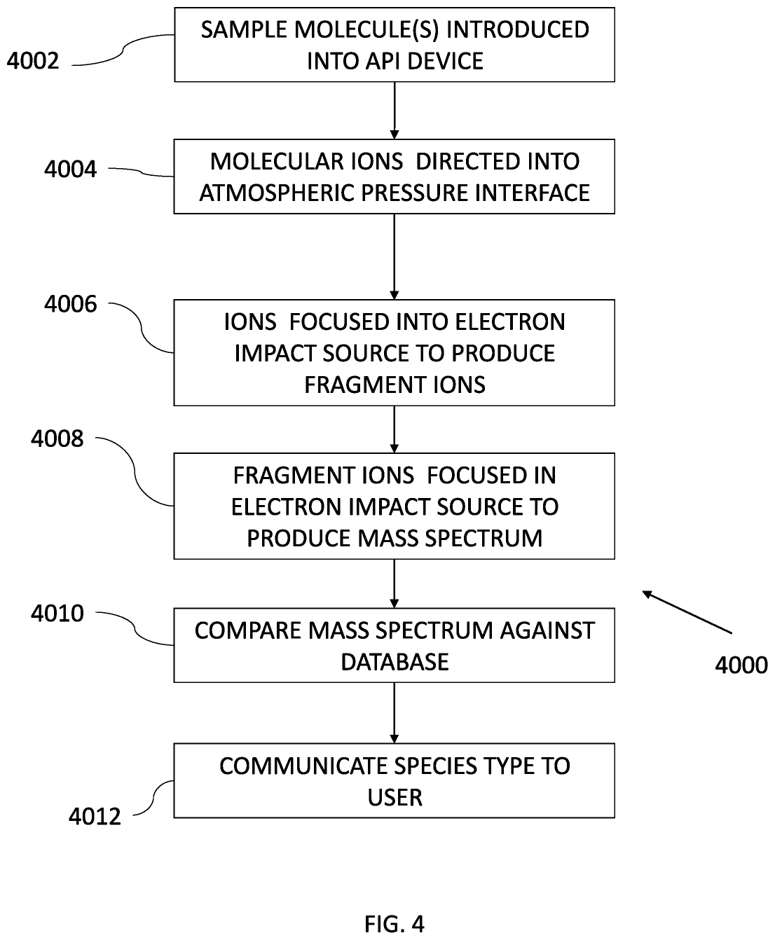

FIG. 4 is a flow chart illustrating a process for analyzing a sample molecule in accordance with some embodiments of the present disclosure. In STEP 4002, a sample molecule, for example, is/are introduced into an atmospheric pressure ionization device 2003a, 2003b, 2003c, and subjected to the respective ionization process to form sample molecular ions. In STEP 4004, the sample ions are transferred into the atmospheric pressure interface 2001 where through pressure differentials including the use of one or more lenses, capillaries and/or electrostatic voltages the sample ions are focused into the electron impact source 2005. In STEP 4006, the sample ions and/or molecules are subjected to an electron ionization process under vacuum, for example, 70 eV electron ionization via the electron impact source 2005, to produce fragmentation ions, which are analyzed and detected via the mass analyzer 2007 and detector 2009, to produce a mass spectrum. (STEP 4008). The generated mass spectrum may be represented as a visual on a screen associated with the processor 999. The generated mass spectrum is compared to a mass spectral library database associated, or in communication with, the processor. (STEP 4010). A determination or percentage probability library match of the analyte identified is communicated to the user. (STEP 4012).

Any software and/or firmware including a mass spectrometer analysis process for an API/EI impact ionization mass spectrometer system according to illustrative embodiments of the present disclosure can be provided on a computer readable non-transitory storage medium. A computer readable non-transitory storage medium as non-transitory data storage includes any data stored on any suitable media in a non-fleeting manner. Such data storage includes any suitable computer readable non-transitory storage medium, including, but not limited to hard drives, nonvolatile RAM, SSD devices, CDs, DVDs, etc.

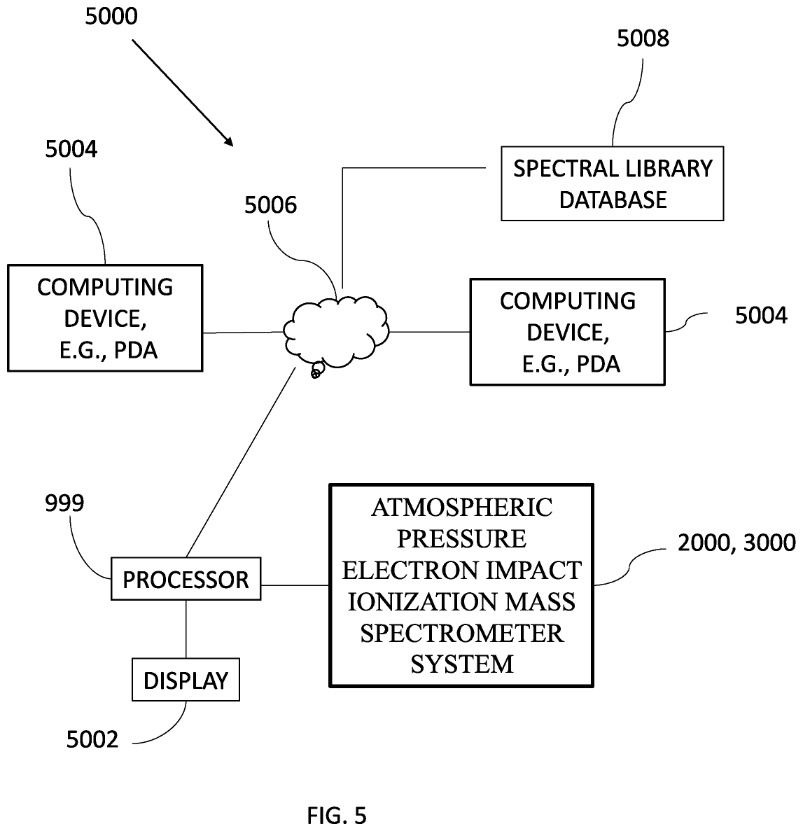

FIG. 5 illustrates a computing/communications system according to one or more embodiments of the present disclosure. In illustrative embodiments, the computing/communications system 5000 includes the atmospheric pressure electron impact ionization mass spectrometer system 2000, 3000, the processor 999 and a display 5002. The processor 999 and the display 5002 may or may not be incorporated into the atmospheric pressure electron impact ionization mass spectrometer system 2000, 3000. One or more computing devices 5004 (such as for example, a smartphone, tablet, portable computer, iPhone, etc. (hereinafter, referred to as a PCD) are in communication with at least one of the processor 999 of the atmospheric pressure electron impact ionization mass and/or spectrometer system 2000, 3000 via a network 5006. The network 5006 may include, for example, a global computer network such as the Internet, a wide area network (WAN), a local area network (LAN), a satellite network, a telephone or cable network, or various portions or combinations of these and other types of networks (including wired and/or wireless networks). In illustrative embodiments, the computing system 5000 may be a LAN-based environment where all processing and analysis can be performed by one or more computing devices that are locally coupled to the LAN. In one or more embodiments, the computing system environment employs a cloud computing platform, where “cloud” refers to a collective computing infrastructure that implements a cloud computing paradigm. The processor 999 and/or the atmospheric pressure electron impact ionization mass spectrometer system 2000, 3000 is in communication with a spectral library database 5008 through, for example, the network 5006. The spectral library database 5008 may be remote from the processor 999 such that they are connected via the network. In illustrative embodiments, the one or more computing devices 5004 may include the processor 999. In other embodiments, the one or more computing devices 5004 are in communication with the processor 999 and/or the atmospheric pressure electron impact ionization mass spectrometer system 2000, 3000 such that the status and/or results of operation of the system in accordance with the process of FIG. 4 may be continually monitored and/or displayed on the one or more computing devices 5004. In some embodiments, the status and/or results of the process may be visualized on the display 5002 associated with the processor 999 to present the results associated with the mass spectra. Other arrangements are also contemplated.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. An atmospheric pressure electron impact ionization mass spectrometer system comprising:
a. an atmospheric pressure ionization component operated at an atmospheric pressure;
b. an electron impact ionization mass spectrometer component comprising an electron ionization source; and
c. an atmospheric pressure interface component operated below about 10 Torr, the atmospheric pressure interface component including a source block to focus a plurality of molecules and ions from the atmospheric pressure ionization component at the atmospheric pressure into the electron ionization source, the electron ionization source operating at a pressure below about 10⁻³ Torr.

2. The atmospheric pressure electron impact ionization mass spectrometer system of claim 1, wherein the atmospheric pressure ionization component comprises an electrospray ionization (ESI) component.

3. The atmospheric pressure electron impact ionization mass spectrometer system of claim 1, wherein the atmospheric pressure ionization component comprises an atmospheric pressure chemical ionization (APCI) component.

4. The atmospheric pressure electron impact ionization mass spectrometer system of claim 1, wherein the atmospheric pressure ionization component comprises an atmospheric pressure analysis probe (ASAP) component.

5. The atmospheric pressure electron impact ionization mass spectrometer system of claim 1, further comprising a processor operatively coupled to at least the electron impact ionization mass spectrometer component, the processor configured to execute a mass spectrometer analysis process.

6. The atmospheric pressure electron impact ionization mass spectrometer system of claim 5, wherein the electron ionization source comprises a 70 eV electron ionization source.

7. The atmospheric pressure electron impact ionization mass spectrometer system of claim 6, wherein the processor is in communication with a 70 eV mass spectral library database.

8. The atmospheric pressure electron impact ionization mass spectrometer system of claim 1, wherein the electron ionization source comprises a 40 eV electron ionization source.

9. The atmospheric pressure electron impact ionization mass spectrometer system of claim 1, wherein the source block optics includes at least one of an electrostatic plate and one or more extraction lens.

10. The atmospheric pressure electron impact ionization mass spectrometer system of claim 1, including a pump configured to generate differentially pumped regions.
